(19) United States
(12) Patent Application Publication
(10) Pub. No.: US 2008/0053054 A1
(43) Pub. Date: Mar. 6, 2008

(54) JACK DEVICE IN RIDING LAWN MOWER

(75) Inventors: Suguru OKAMOTO, Ehime-ken (JP); Haruyoshi HONDA, Ehime-ken (JP); Nozomu KATAGAMI, Ehime-ken (JP)

Correspondence Address: GREENBLUM & BERNSTEIN, P.L.C., 1950 ROLAND CLARKE PLACE, RESTON, VA, 20191, US

(73) Assignee: ISEKI & CO., LTD., Ehime-ken (JP)

(21) Appl. No.: 11/468,073

(22) Filed: Aug. 29, 2006

(51) Int. Cl. A01D 34/00

(52) U.S. Cl. 56/14.7

(57) ABSTRACT

In a mid-mower type riding lawn mower provided with a mower 12 arranged between front and rear wheels 2 and 3, a frame member 32 arranged across a right and left width under a floor 7 along the transverse right and left directions is provided in a front part of the floor 7 of a vehicle body 1. An accommodation bracket member 33 for accommodating an extensible type jack device 31 in longitudinal directions is provided in the frame member 32. An opening and closing cover 24 for covering the accommodated jack device 31 is provided. When the front part of the vehicle body 1 is to be lifted up using the jack device 31, the jack device 31 is linked to a supporting bracket member 34 of the vehicle body 1 such that an upper part of the jack device 31 should be in a forward inclined position, so that an end of the jack device 31 is supported in a freely rotatable manner via a ground plate 31d. Then, when the front part of the vehicle body 1 is lifted gradually, the jack device 31 swings from the forward included position via a vertical position into a rearward inclined position, so that the jack device 31 is held in the rearward inclined position. This avoids acting of a large load, and provides handling and maintenance easiness.

### TECHNICAL FIELD

The present invention relates to a mid-mower type riding lawn mower and, in particular, to a riding lawn mower provided with a jack device for raising a vehicle body front at the time of attachment and detachment of a lawn mower unit or at the time of maintenance.

### BACKGROUND OF THE INVENTION

In a prior art, in a riding lawn mower of this kind as shown in Japanese Published Unexamined Patent Application No. 2000-342040 (Prior Art 1), a rotation shaft in the forward and rearward directions is arranged in a middle part relative to the right and left of a vehicle body-side frame, while a middle part of a front wheel support frame is linked to the rotation shaft in a freely rotatable manner. Then, the front wheel support frame is forcedly rotated relative to the vehicle body-side frame by a jack device so that the vehicle body front is brought into a lifted position in a state that rear wheels serve as a fulcrum.

In the present specification, the right and left directions relative to the forward moving direction of a riding lawn mower are referred to as the right and the left, respectively. Further, the forward moving direction of a vehicle body 1 is referred to as the forward, while the opposite direction is referred to as the rearward.

In the riding lawn mower of the prior art, when the lawn mower unit is to be attached and detached or alternatively when maintenance is to be performed, the vehicle body front is brought into a raised position. However, in this maintenance state, in order that a floor of a driving part should not disturb when the front wheel support frame is raised into a largely inclined state, time and effort have been necessary for detaching the entire floor from the vehicle body. Additionally, in order that caster type front wheels should not be steered, time and effort have been necessary for fixing the wheels. As such, improvement has been desired in the maintenance easiness.

Japanese Published Unexamined Patent Application No. 2004-236616 (U.S. Pat. No. 6,973,768 B2: Prior Art 2) discloses a riding lawn mower in which a mower is linked between front wheels and rear wheels in a vehicle body and in which a jack is equipped inside a front part frame oriented in the right and left directions on a front wheel side of the vehicle body. In the configuration of this riding lawnmower, the jack can be switched by swinging between an accommodation position where the jack is aligned inside the front part frame and an operating position where the jack is raised vertically, in a state a rotation fulcrum at an end of the jack provided in the front part frame serves as a center. Then, after the jack is switched into the operating position where the jack is raised up, one cylinder of the jack constructed in the form of a double cylinder is extracted from the inside of the other cylinder, and then the jack is extended by rotation operation of a handle. Then, in this state that the front part of the vehicle body is retained in a lifted position by the extended jack, the maintenance for the mower is performed.

However, in Prior Art 2, when the front part of the vehicle body is lifted up by the jack, as the jack raised into the vertical direction relative to the ground lifts up the front part of the vehicle body, the jack becomes largely inclined rearward relative to the vertical direction. When the jack is brought into the rearward inclined position, the jack constructed from two cylinder members bends so that a large load acts at the time of extension of the jack. Thus, the handle operation force necessary for jack extension increases remarkably.

### SUMMARY OF THE INVENTION

An object of the present invention is to provide a riding lawn mower provided with a jack device that can lift up a front part of a vehicle body without acting of a large load and that does not disturb even when the jack is accommodated in the vehicle body in normal work.

The above-mentioned object of the present invention is solved by the following solving means.

That is, the invention according to a first aspect is a riding lawn mower including:

a pair of front wheels (2, 2) and a pair of rear wheels (3, 3) provided in a vehicle body (1);

a lawn mower unit (12) whose front end is linked to and supported by the vehicle body (1) between the pair of front wheels (2, 2) and the pair of rear wheels (3, 3);

a frame member (32) provided in a front part of the vehicle body (1) across right and left width directions relative to a moving direction of the vehicle body (1);

an extensible jack device (31) comprised with two or more cylinders (31b, 31c) which have different diameters and can extend and contract between a position where the cylinders (31b, 31c) are stacked and accommodated inside and outside and the other position where the inner cylinder (31c) protrudes and extends, a ground plate (31d) which contacts with a ground contact surface and is attached to an end of the cylinder (31c) in a freely rotatable manner and a linkage part (31e) which is provided between the cylinder (31c) and the ground plate (31d) and serves as a ground swing fulcrum;

accommodation bracket members (33, 33) provided in the frame member (32) in order to accommodate the extensible jack device (31) in a freely attachable and detachable manner; and

a jack device supporting bracket member (34) provided in a center part in the right and left directions of the frame member (32) in order to link and support the extensible jack device (31) in a position inclined forward relative to the vertical direction after being detached from the accommodation bracket members (33, 33), wherein
in an initial state of being linked to the jack device supporting bracket member (34), the extensible jack device (31) is supported in a position inclined forward relative to the vertical direction by the jack device supporting bracket member (34) in a state that the linkage part (31e) serves as a ground swing fulcrum, wherein in association with successive extension, the jack device (31) is brought into a rearward inclined position via a vertical position and then is supported in the rearward inclined position by the jack device supporting bracket member (34).

The invention according to a second aspect is a riding lawn mower according to the first aspect, wherein a floor (7) is provided that covers from the above the lawn mower unit (12) supported by the vehicle body (1), and an cover (24) that can be opened and closed and that covers the frame member (32), the accommodation bracket members (33, 33), and the jack device supporting bracket member (34) is provided in front of the floor (7).

The invention according to a third aspect is a riding lawnmower according to the first aspect, wherein a reinforcement support members (37, 38) that supports and reinforces the cover (24) when the cover (24) is closed is provided between the accommodation bracket members (33, 33) and the cover (24).

According to the present invention of the first aspect, when the lawn mower unit (12) installed in the vehicle body (1) is to be detached from the vehicle body (1) for the purpose of maintenance, the jack device (31) is detached from the accommodation bracket members (33, 33) and then linked to the jack device supporting bracket member (34) provided in a center part of the right and left directions. Then, in this initial state, the jack device (31) is in a position inclined forward relative to the vertical direction in a state that the linkage part (31e) between the cylinder (31c) and the ground plate (31d) of the jack device (31) serves as a ground swing fulcrum.

In the initial state that the jack device (31) is linked to the bracket member (34), the jack device (31) is brought into a position inclined forward relative to the vertical direction in a state that the linkage part (31e) of the ground plate (31d) attached in a freely rotatable manner to the end of the cylinder (31c) that contacts with the ground contact surface at the time of extension of the jack device (31) serves as a ground swing fulcrum. In this forward inclined position, the jack device (31) is linked to and supported by the bracket member (34). Then, in association with the successive extension of the cylinder (31c) of the jack device (31), the jack device (31) is brought into a rearward inclined position via a vertical position and then linked to and supported by the supporting bracket member (34) in this rearward inclined position.

The extension of the jack device (31) is performed such that starting from a state that the plurality of cylinders are stacked, the other cylinders slide in the inside of the cylinder linked to the supporting bracket member (34). At that time, in a state that the linkage part (31e) on the ground contact surface of the jack device (31) serves as a swing fulcrum, the jack device (31) extends with swinging from a position inclined forward relative to the vertical direction via a vertical position into a rearward inclined position.

If the initial state were in a vertical direction, the angle of a rearward inclined position could be large so that the amount of bend of the jack device (31) could be large. However, as described above, the amount of angle change in the rearward inclined position is taken into account in advance so that the jack device (31) is extended starting from a forward inclined position. By virtue of this, even when the jack device (31) is extended, the angle of inclination in the rearward inclined position of the jack device (31) becomes small relative to the vertical direction.

Thus, the plurality of cylinders (31b,31c) stacked with each other and thereby constituting the jack device (31) do not bend, so that the cylinders (31b,31c) slide smoothly without interfering with each other. Thus, a large load does not act against a rotation operation force in a handle (31a) or the like for extending the jack device (31). This allows even a small operation force to extend the jack device (31). And in a state that the jack device (31) linked to and supported by the jack device supporting bracket member (34) has extended, the front part of the vehicle body (1) goes up in a state that the pair of rear wheels (3, 3) serve as a fulcrum so that the front part of the lawn mower unit (12) can also go up simultaneously.

Further, since the linkage part (31e) serving as a swing fulcrum of the ground plate (31d) on the ground contact surface of the jack device (31) is fixed, good operability of extension and contraction is obtained in the jack device (31).

Further, the frame member (32) to which the accommodation bracket members (33, 33) are attached is provided across the right and left width under the floor (7). Thus, the maximum length of the right and left width of the vehicle body (1) is ensured. Accordingly, the length of the jack device (31) itself to be accommodated into the accommodation bracket members (33, 33) can be constructed in a long length. That is, the extension length of the jack device (31) achieved when the cylinders of the jack device (31) are slid is ensured long. This ensures a sufficient height when the lawn mower unit (12) is detached from the vehicle body (1) for the purpose of maintenance is perform, and hence ensures maintenance easiness in the lawn mower unit (12).

According to the invention of the first aspect, since the extension length of the jack device (31) is ensured long, a sufficient height is easily ensured for detaching the lawn mower unit (12) from the vehicle body (1) for the purpose of maintenance. Further, since the right and left front wheels (2, 2) are lifted up together with the lawn mower unit (12), a large space is formed under the vehicle body so that the maintenance work becomes easy.

Further, in the use of the jack device (31), since the support part for linking this jack device (31) is also provided in the frame member (32), handling operation of this device (31) is easily understood while its operation is also easy. Furthermore, in the accommodating of the jack device (31), the jack device (31) can be held along the frame member (32) so that the accommodation is performed compactly.

Further, in the use of the jack device (31), the jack device (31) extends by swinging from the position inclined forward relative to the vertical direction via the vertical direction into the rearward inclined position in a state that the lower end part (the linkage part 31e) on the ground contact surface of the jack device (31) serves as a swing fulcrum. This allows even a small operation force to extend the jack device (31). Further, since the lower end part (the linkage part 31e) serving as a swing fulcrum on the base surface of the jack device (31) is fixed, good operability of extension and contraction is obtained in the jack device (31).

According to the invention of the second aspect, since the cover (24) is closed at the time of non-use of the jack device (31), the jack device (31) can be accommodated into the accommodation bracket members (33, 33) in a manner safe and not disturbing the worker at the time of work.

According to the invention of the third aspect, the reinforcement support members (37, 38) are provided for reinforcement support. This avoids that the cover (24) deforms when the cover (24) is closed.

### BRIEF DESCRIPTION OF THE DRAWINGS

FIG. 1 is a general side view of a riding lawn mower;

FIG. 2 is a front part side view of a riding lawn mower;

FIG. 3 is a side view showing the operation of an opening and closing cover;

FIG. 4 is a plan view of an opening and closing cover part;

FIG. 5 is a plan view showing an accommodated state of a jack device;

FIG. 6A is a plan view of an opening and closing cover part according to a first another embodiment;

FIG. 6B is a side view of an opening and closing cover part according to a first another embodiment;

FIG. 7A is a plan view of an opening and closing cover part according to a second another embodiment;

FIG. 7B is a side view of an opening and closing cover part according to a second another embodiment;

FIG. 8A is a plan view of an opening and closing cover part according to a third another embodiment;

FIG. 8B is a side view of an opening and closing cover part according to a third another embodiment;

FIG. 8C is an enlarged side view of a main part;

FIG. 9A is a side view in which a carrier is provided to a supporting bracket;

FIG. 9B is a perspective view of the above-mentioned carrier;

FIG. 10 is a sectional plan view showing a transmission unit for a lawn mower unit;

FIG. 11 is a sectional rear view showing a transmission configuration of a riding lawn mower; and

FIG. 12 is a sectional rear view showing a transmission configuration for rear wheels.

### DETAILED DESCRIPTION OF THE PREFERRED EMBODIMENTS

A riding lawn mower employing the present invention is described below with reference to the drawings.

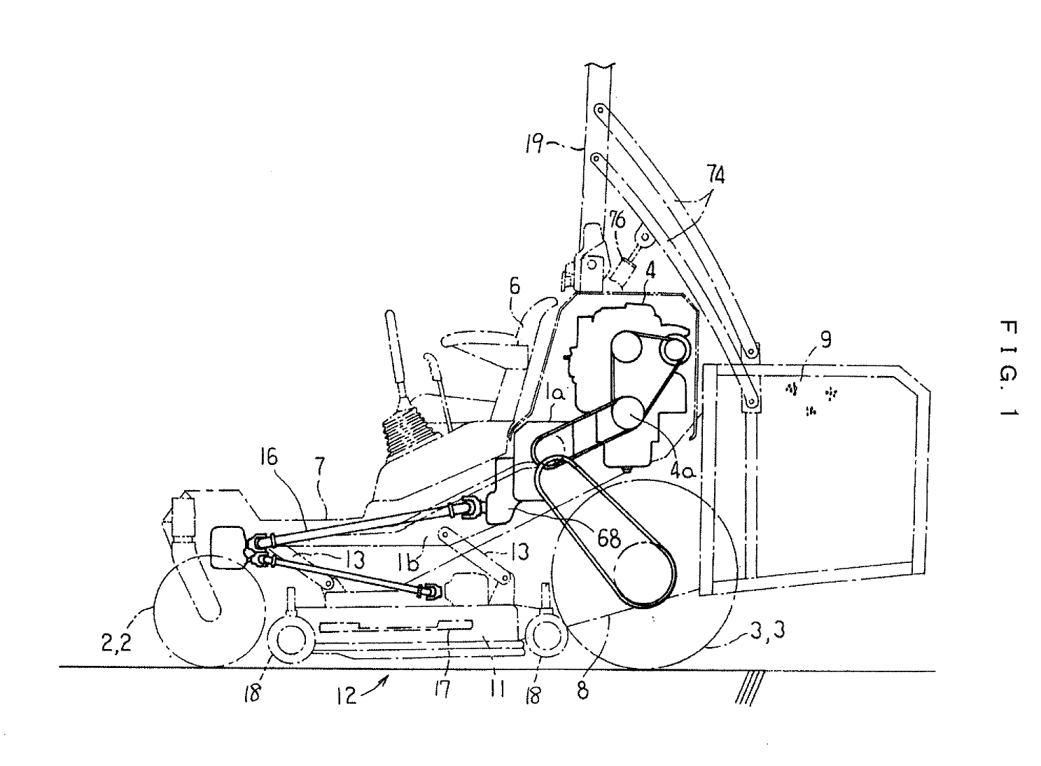

As shown in FIG. 1, in a riding lawn mower, a vehicle body 1 is constructed from a transmission case 1a and a vehicle body frame 1b attached to a front end part of the case. A pair of caster type front wheels 2, 2 are provided in the right and left on a front end side of the vehicle body 1, while a pair of rear wheels 3, 3 for driving are provided in the right and left on a rear end side of the vehicle body 1. Further, an engine 4 is provided above the shaft of the rear wheels 3, 3 in the vehicle body 1. Furthermore, a driver's seat 6 is provided in the vehicle body 1 on a front side relative to the engine 4 of the vehicle body 1. In the vehicle body 1, a floor 7 extending from the under of the driver's seat 6 to the front side is provided. Further, a lawn mower unit 12 provided with cutting blades 17 in the inside is attached between the front wheels 2, 2 and the rear wheels 3, 3 of the vehicle body 1 in a freely raised and lowered manner via an elevator linkage mechanism 13. A PTO power is extracted from a transmission unit located between the right and left rear wheels 3, 3, and then transmitted to the lawn mower unit 12.

The lawn mower unit 12 is constructed from: a mower deck 11; a plurality of cutting blades 17, . . . that are arranged along the right and left directions in the mower deck 11 and that revolve about a vertical axis; gauge wheels 18, 18, . . . provided in the front and rear and the right and left of the mower deck 11; and the like. Then, the elevator linkage mechanism 13 is operated downward so that the lawn mower unit 12 is lowered from the vehicle body 1 into a state that the gauge wheels 18 . . . contact with the ground. When the vehicle body runs, the cutting blades 17 . . . revolved by a power transferred from the engine 4 cut grasses at a predetermined height. The grasses cut by the lawn mower unit 12 are collected into a collector 9 in a rear part of the vehicle body via a chute 8 provided between the right and left rear wheels 3, 3.

Further, a safety frame 19 having a gate shape in a front view is provided on the right and left sides of the engine 4 on the rear side of the driver's seat 6. Then, collector elevator lift mechanisms 74, 74 are provided in an upper part of the safety frame 19, and thereby support the collector 9 arranged between the right and left rear wheels 3, 3. The collector 9 can freely be raised and lowered by means of a collector elevator cylinder 76. The collector 9 can be arranged near the rear part of the vehicle body. This improves the grass collecting performance.

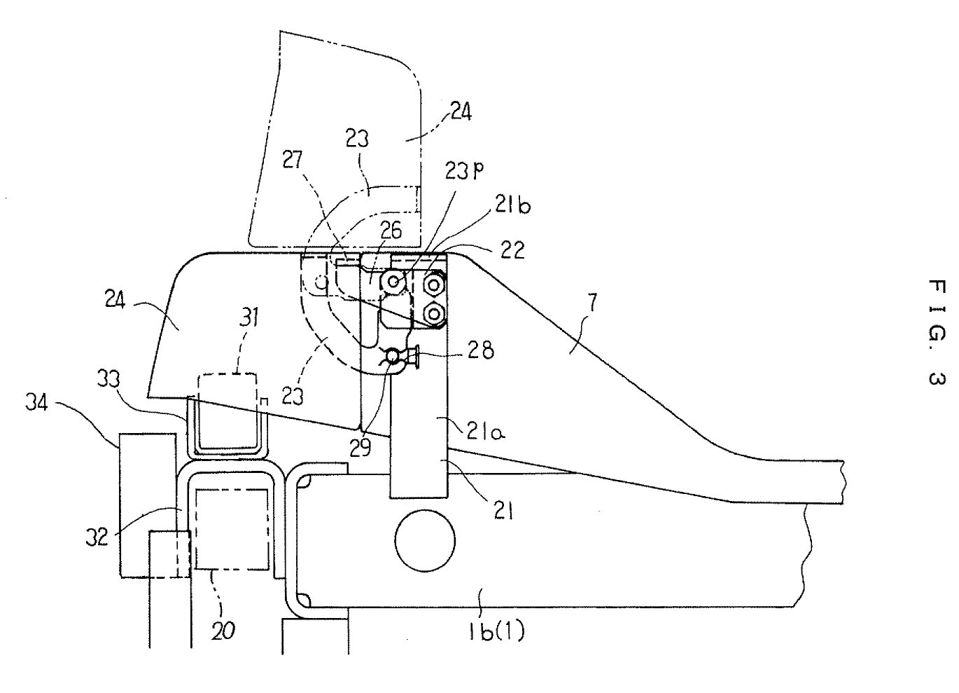

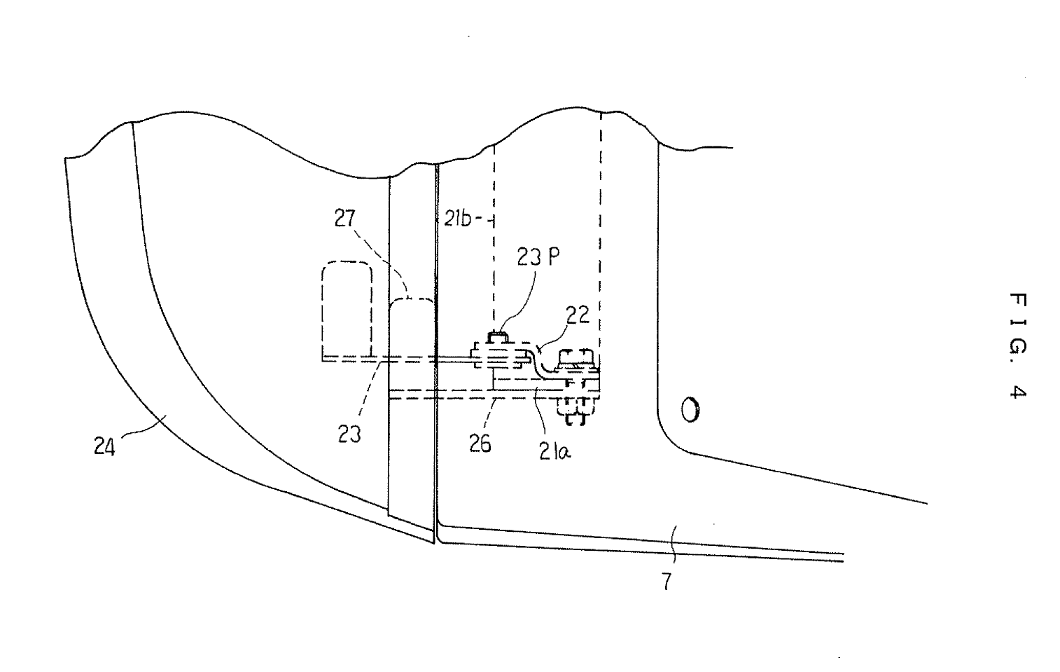

Next, the configuration of the front part of the floor 7 is described below with reference to FIG. 3 and FIG. 4.

In the vehicle body frame 1b of the vehicle body 1, a step frame 21 is provided in the front upper part thereof, while this frame 21 supports the front part of the floor 7.

The step frame 21 is constructed in a gate shape in a front view by: two up-and-down step frames 21a, 21a each arranged vertically at each of the right and left positions; and a right-and-left step frame 21b provided in the right and left directions and thereby connecting the upper ends of the up-and-down step frames 21a,21a. The lower ends of the up-and-down step frames 21a, 21a are attached to the vehicle body frame 1b, while the upper surface of the right-and-left step frame 21b contacts with and supports the lower surface of the floor 7.

Further, right and left cover fixing plates 22, 22 are attached to the up-and-down step frames 21a, 21a in the right and left of the step frame 21, while right and left rotation arms 23, 23 having a bent shape are attached to the cover fixing plates 22, 22 in a freely rotatable manner about a pin 23P. Further, an opening and closing cover 24 located in plane with the front side of the floor 7 is attached to the rotation arms 23, 23. This opening and closing cover 24 is rotated downward into a closed state shown with solid lines where the front end part of the vehicle body frame 1b is covered from the above, or alternatively rotated upward into an opened state shown with imaginary lines.

Further, opening stoppers 27, 27 are attached to the arms 26, 26 fixed integrally to the right and left up-and-down step frames 21a, 21a, so that the opening stoppers 27, 27 restrict the upward rotation of the rotation arms 23, 23. Further, locking pieces 28 and 28 provided in the up-and-down step frames 21a, 21a are fit with locking pins 29 and 29 provided in the rotation arms 23, 23, so that the opening and closing cover 24 in a closed state is locked.

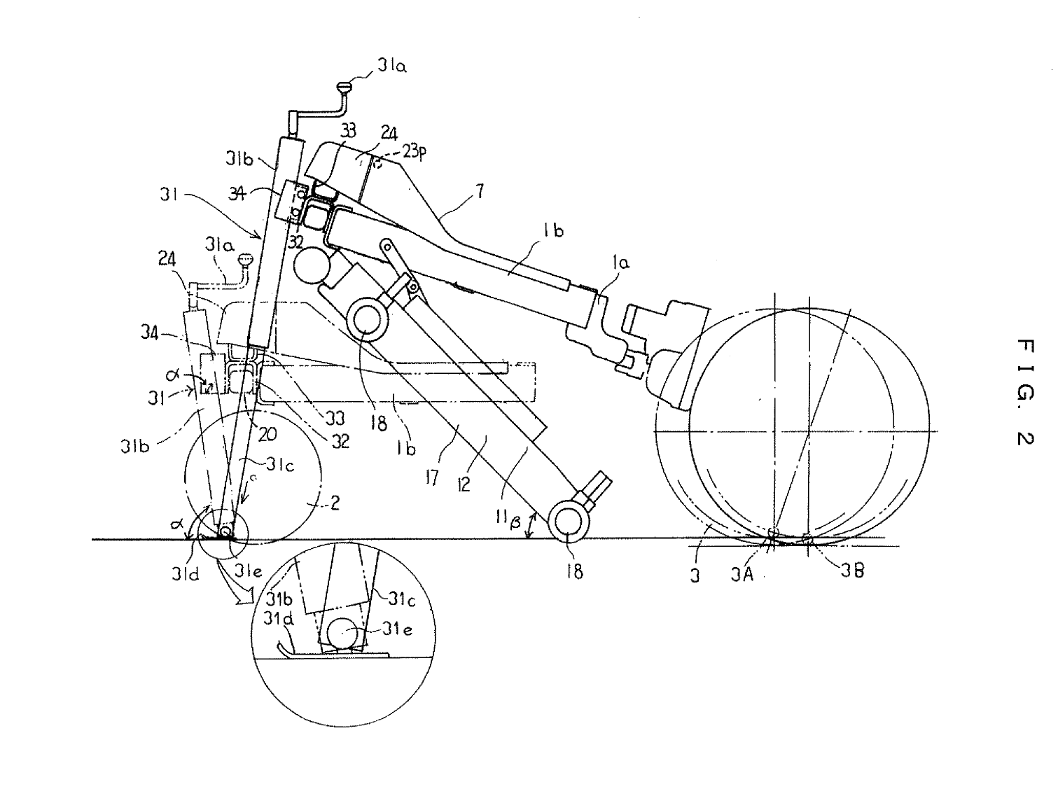

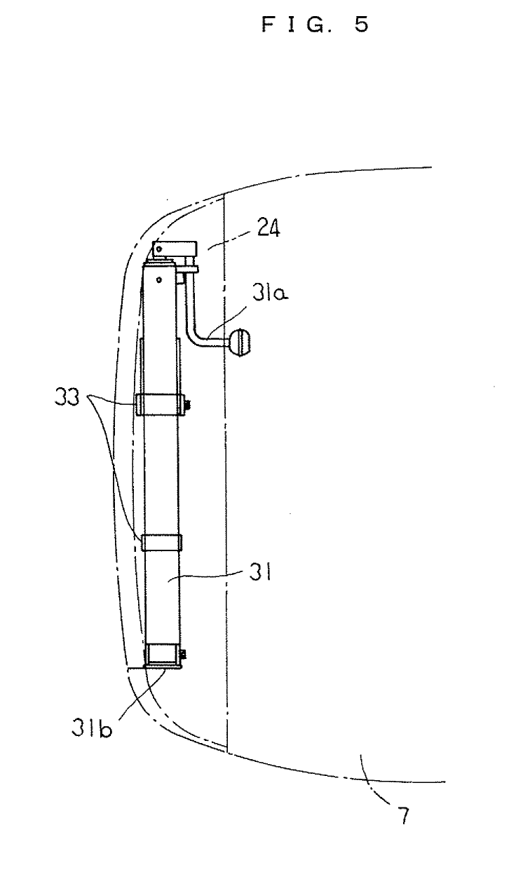

Next, a jack device 31 for lifting up the front-side part of the vehicle body 1 is described below with reference to FIG. 2 and FIG. 5.

An attaching frame 32 is attached to the front end part of the vehicle body frame 1b along the right and left directions, while a supporting bracket 20 for the front wheels 2, 2 is supported on the frame 32 in a manner permitting free rolling in the right and left directions. Further, the above is covered by the opening and closing cover 24. Furthermore, accommodation brackets 33, 33 for the jack device 31 having a concave shape are attached to the upper part of the attaching frame 32 with appropriate spacing. The longitudinal direction of the jack device 31 is fit in and supported along the recess of the brackets 33, 33. Further, a supporting bracket 34 having a concave shape and protruding toward the front side is attached to the center part of the right and left directions of the attaching frame 32.

The jack device 31 is constructed from: a handle 31a having a shaft; a cylinder 31b having a larger diameter; and a cylinder 31c having a smaller diameter. Starting from a position where the cylinder 31c having the smaller diameter is stacked in the cylinder 31b having the larger diameter, one cylinder can be slid into an extended position so that the entirety can be extended and contracted. A slide mechanism for the cylinder 31b and the cylinder 31c has a well-known configuration. For example, a rack is provided in the entire outer periphery of the shaft of the handle 31a, while a pinion provided in the inner periphery of the upper end of the smaller diameter cylinder 31c is fit in with the rack by screw fitting. Then, when rotation operation of the handle 31a causes the cylinder 31c to slide inside the larger diameter cylinder 31b in association with the rotation of the rack of the handle 31a, the jack device 31 can be extended and contracted. Further, a ground plate 31d is pivotally supported with the linkage part 31e in the right and left directions in the lower end part of the smaller diameter cylinder 31c of the jack device 31.

In the above-mentioned configuration, during the running operation of the riding lawn mower, the longitudinal direction of the jack device 31 is fit in along the recess of the accommodation brackets 33, 33 provided in the attaching frame 32, and then, for example, a pin stop (not shown) is used so that the opening and closing cover 24 is closed. Further, when the front-side part of the vehicle body 1 is raised so that the lawn mower unit 12 is attached and detached, or alternatively when maintenance is performed, in a state that the brake is activated on the rear wheels 3, 3, the opening and closing cover 24 is opened and then the jack device 31 is released from the pin stop of the accommodation brackets 33, 33. Then, the longitudinal direction of the jack device 31 is turned vertically, then fit into the supporting bracket 34 in the center part of the vehicle body 1, and then attached using the pin. At that time, the jack device 31 is attached to the supporting bracket 34 in a state that the ground plate 31b contacts with the ground in a forward inclined position at a predetermined angle α relative to the ground contact surface in a side view as shown in FIG. 2. Then, the handle 31a is rotated so that the jack device 31 is extended, there by the front-side part of the vehicle body 1 is raised up. In association with the successive extension of the jack device 31, the jack device 31 is brought into a rearward inclined position via a vertical position, and then is supported by the bracket 34.

In a state that the jack device 31 supported by the bracket 34 has extended, the front part of the vehicle body 1 goes up in a state that the pair of rear wheels 3, 3 serve as a fulcrum, so that the front part of the lawn mower unit 12 also goes up simultaneously. At that time, the lawn mower unit 12 is raised up at a predetermined angle (approximately 45 degrees) relative to the ground. In this state, the lawn mower unit 12 may be detached, or alternatively checked in this state.

The extension of the jack device 31 is performed such that starting from a state that the cylinders 31b and 31c are stacked, the cylinder 31c slides in the inside of the cylinder 31b linked to the bracket 34. At that time, in a state that the right-and-left shaft serving as the linkage part 31e between the ground contact plate 31d and the cylinder 31c of the jack device 31 serves as a swing fulcrum, the jack device extends with swinging from a position inclined forward relative to the vertical direction via a vertical position into a rearward inclined position. During this operation, the cylinders 31b and 31c of the jack device 31 slide smoothly, so that the cylinders 31b and 31c do not bend. Thus, a large load does not act against a rotation operation force in the handle 31a for extending the jack device 31. This allows even a small operation force to extend the jack device 31.

Further, since the right-and-left shaft (linkage part 31e) on the ground plate 31d of the jack device 31 is fixed, good operability of extension and contraction is obtained in the jack device 31. In contrast, in the configuration of the above-mentioned Prior Art 2, in the start up of the jack device, the jack device is attached in a vertical position in the front part of the vehicle body. Thus, when the jack device is extended, the jack device is inclined rearward. Further, when the front of the vehicle body is raised higher, the ground contact part of the jack device moves. This causes bend in the jack device constructed in the form of a double cylinder capable of sliding, and hence causes a remarkably large load in the extending jack device.

Further, in the attaching frame 32 to which the accommodation brackets 33, 33 are attached according to this embodiment, the same length as the right and left width of the vehicle body is ensured at maximum. Thus, the extension length of the jack device 31 obtained when the cylinders 31b and 31c of the jack device 31 accommodated in the accommodation brackets 33, 33 are slid is such that a sufficient height is ensured for detaching the lawn mower unit 12 from the vehicle body 1 for the purpose of maintenance. This ensures maintenance easiness in the lawn mower unit 12.

In the jack device 31 in the riding lawn mower having the above-mentioned configuration, when the front part of the vehicle body 1 is lifted up, the right and left front wheels 2, 2 are lifted up simultaneously. Thus, a large space is formed under the vehicle body so that the maintenance work becomes easy.

Further, in the use of the jack device 31, since the supporting bracket 34 for linking the jack device 31 is also provided in the attaching frame 32, handling operation of this device 31 is easily understood while its operation is also easy. Further, in the accommodating of the jack device 31 into the accommodation bracket 33, the jack device 31 is accommodated along the attaching frame 32 so that the accommodation is performed compactly.

Next, other embodiments are described below for the attaching frame 32 provided with the accommodation bracket 33 and the supporting bracket 34 of the jack device 31.

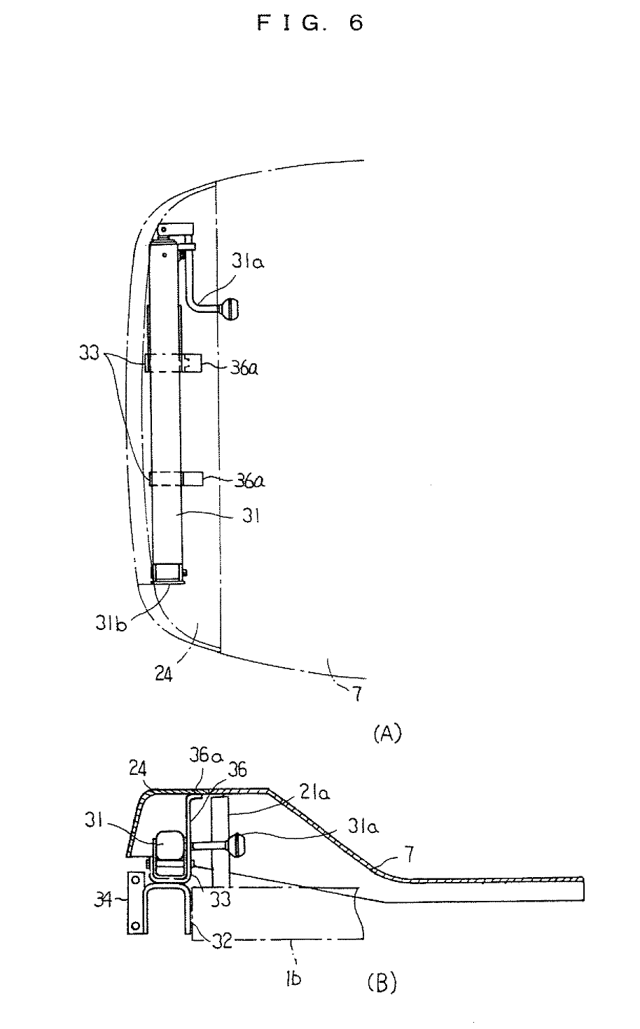

In a first another embodiment, as shown in FIG. 6, an extension part 36 extending upward is provided in a rear part of the accommodation bracket 33, while a bent part 36a is constructed at the upper end of the extension part 36, so that the bent part 36a receives the lower surface of the opening and closing cover 24 in the closed state.

By virtue of this, the strength of the opening and closing cover 24 in the closed state is increased so that deformation is avoided that could be caused when the operator sits on or alternatively places a foot on the cover 24.

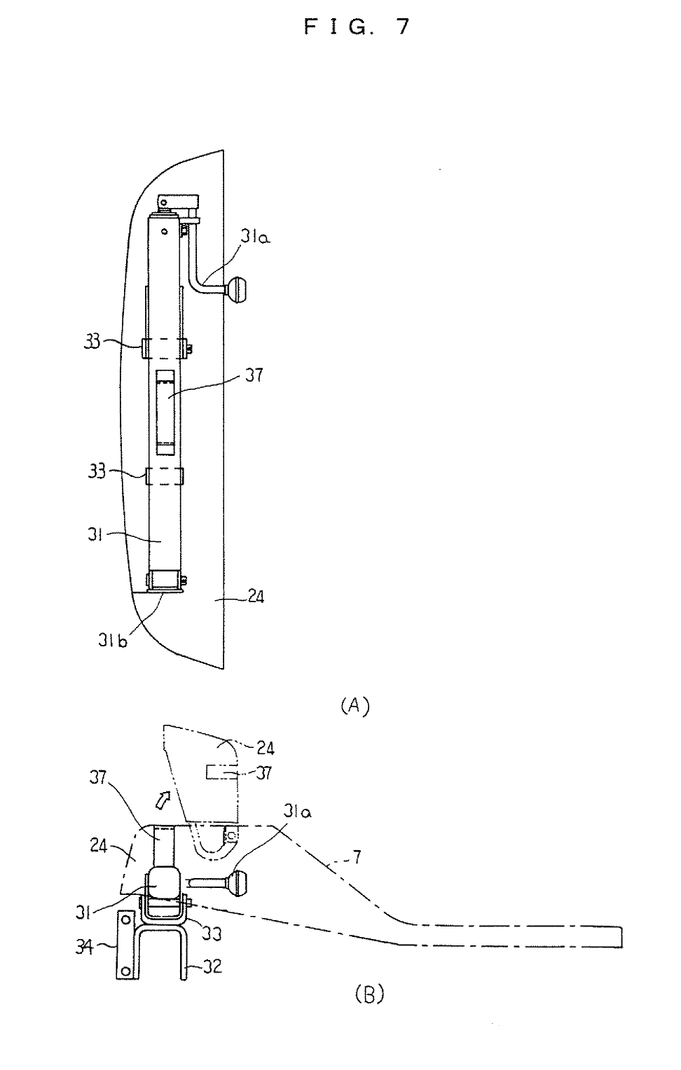

Further, in a second another embodiment, as shown in FIG. 7, a press plate 37 is attached to the lower surface of the opening and closing cover 24, so that the jack device 31 supported by the accommodation bracket 33 at the time of closing of the opening and closing cover 24 is pressed downward by the press plate 37.

This ensures the supporting of the jack device 31 with increasing the strength of the opening and closing cover 24.

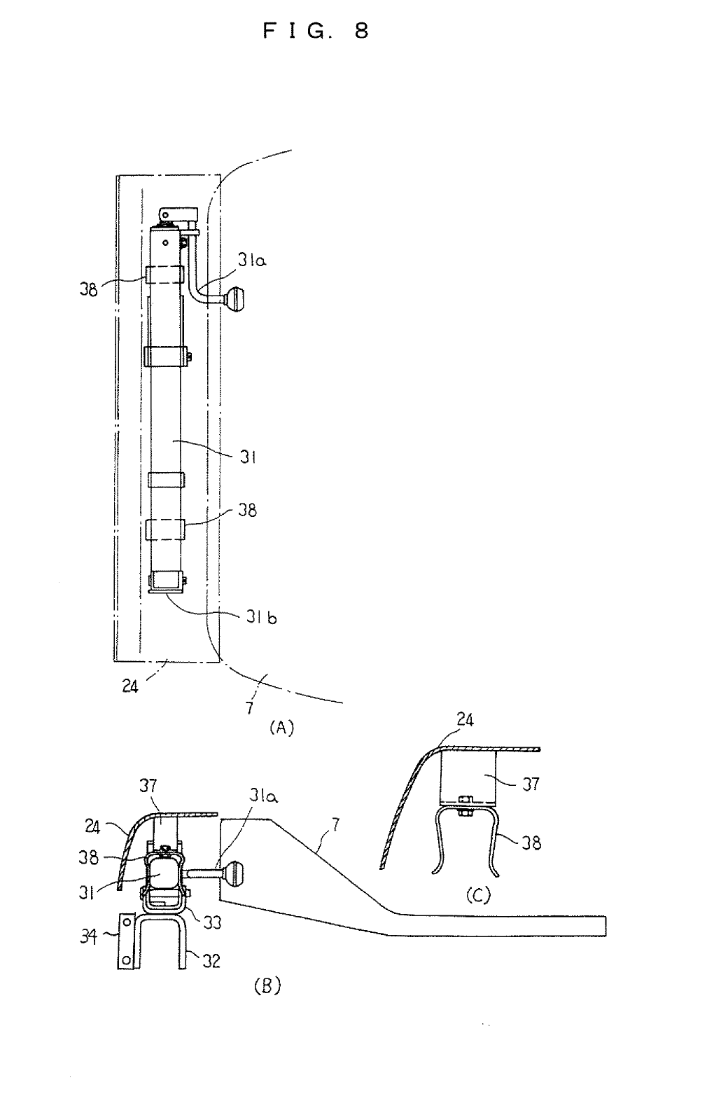

Furthermore, in a third another embodiment, as shown in FIG. 8, a support part 38 having a blade spring material is attached to the stopper plate 37, while the jack device 31 supported by the accommodation bracket 33 is pressed by the stopper plate 37 of the opening and closing cover 24 having been closed, and while the jack device 31 is sandwiched by the support part 38 from the forward and the rearward.

This ensures the supporting of the jack device 31 with increasing the strength of the opening and closing cover 24, similarly to the above-mentioned case.

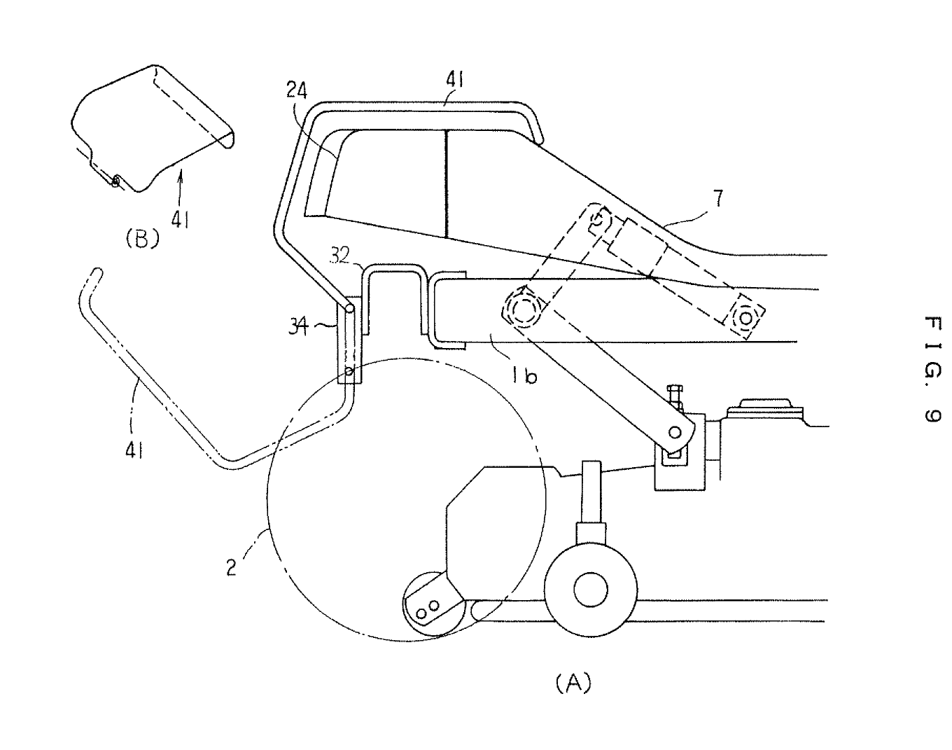

Further, in a fourth another embodiment, as shown in FIG. 9, a carrier is attached by using the supporting bracket 34 of the jack device 31. Specifically, a plate 41 in which a recess in a side view is formed by bending is pivotally supported by the supporting bracket 34 in a freely rotatable manner in the forward and rearward directions. Then, in a protruding state of being rotated forward, the recess is used as a receiving part for the carrier, while in an accommodated state of being rotated rearward, the plate covers the opening and closing cover 24 from the above and hence serves as a guard for the opening and closing cover 24.

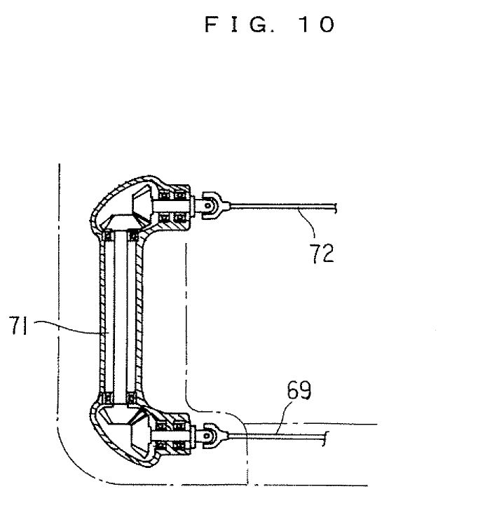

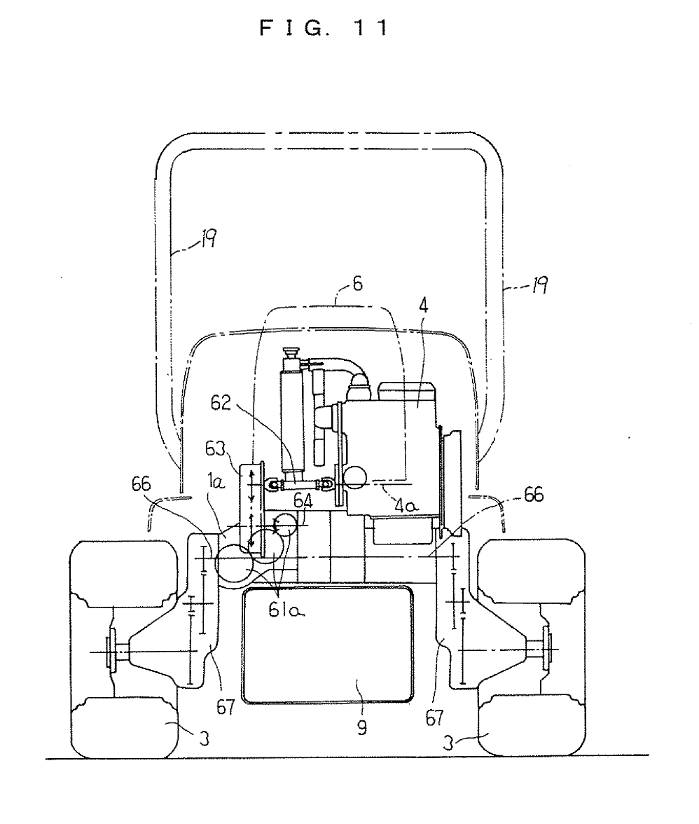

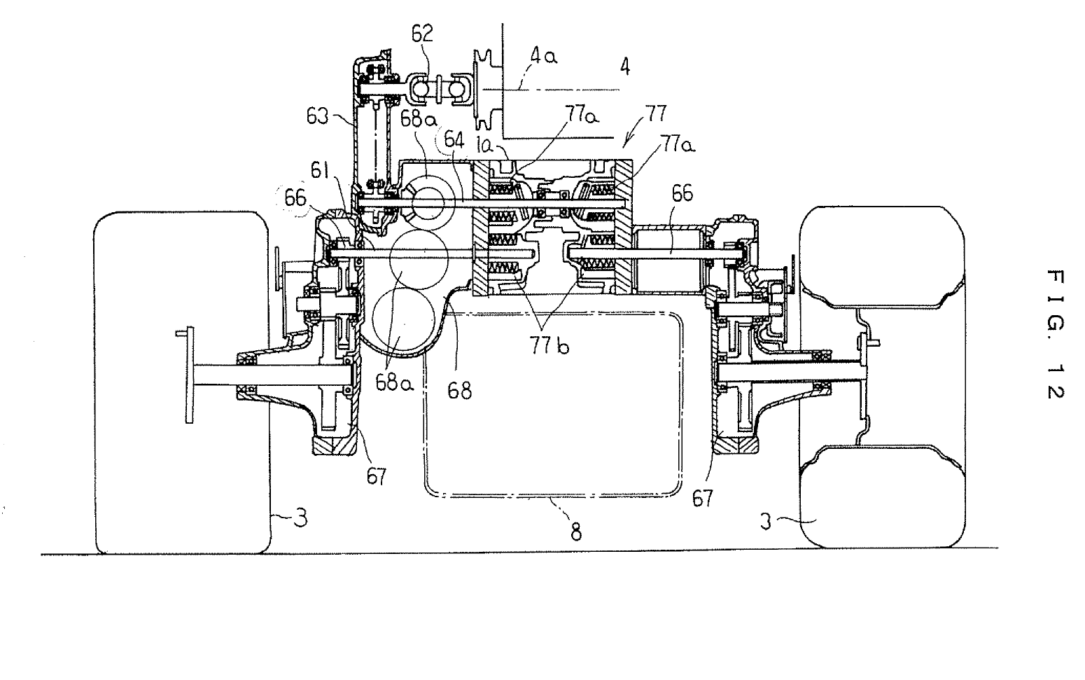

Next, the transmission configuration of the riding lawn mower is described below with reference to FIG. 10 to FIG. 12.

In the rear part of the vehicle body 1, the engine 4 is installed in a transverse arrangement behind the driver's seat 6, while a transmission case 1a is provided between the engine 4 and the driver's seat 6 of the vehicle body 1. The power of a crankshaft 4a along the right and left directions of the engine 4 is transmitted to an HST (hydrostatic stepless transmission unit) 77 via a transmission shaft 62 and a transmission unit within a transmission case 63. The MST 77 is constructed from hydraulic pressure pumps 77a, 77a and hydraulic pressure motors 77b, 77b which are independent from each other in the right and left. The power transmitted through the transmission unit in the transmission case 63 and an input shaft 64 is transmitted to the right and left hydraulic pressure pumps 77a, 77a. Then, the speed is changed independently in the hydraulic pressure pumps 77a, 77a by means of rotation operation of right and left trunnion shafts, so that the hydraulic pressure after the speed change is transmitted to the right and left hydraulic pressure motors 77b, 77b so that the motors are driven. Thus, independently speed-changed power is extracted from each of right and left output shaft 66, 66, and then transmitted to each of the right and left rear wheels 3, 3 via each of running transmission units within right and left running transmission cases 67, 67 in the longitudinal directions.

Further, a PTO transmission case 68 is arranged in a position that is between the HST 77 and the transmission case 63 in a rear view and deviated from the vehicle body center. In the upstream of a transmission unit 68a within the PTO transmission case 68, a PTO power is divided from the input shaft 64 by a bevel gear and then slowed down by the transmission unit 68a, so that the PTO power is extracted from in downstream. The PTO power is further transmitted to the lawn mower unit 12 via a PTO shaft 69, a transmission unit within a front part transmission case 71, and a mower transmission shaft 72 (FIG. 10).

As described above, it is avoided that the transmission case 1a and the PTO transmission case 68 disturb. That is, a larger space is obtained under the vehicle body. Thus, a larger passage area is obtained in the chute 8 for passing grasses Further, the PTO power extracted from the PTO transmission case 68 is transmitted to the front side through the PTO shaft 69 via a part deviated from the body center to the right or left side, and then transmitted to the lawn mower unit 12 via the front part transmission case 71 arranged in the right and left directions and located in the front part of the lawn mower unit 12 in a plane view. This increases the amount of lift of the lawn mower unit 12.

What is claimed is:

1. A riding lawn mower comprising:
a pair of front wheels and a pair of rear wheels provided in a vehicle body;
a lawn mower unit whose front end is linked to and supported by the vehicle body between the pair of front wheels and the pair of rear wheels;
a frame member provided in a front part of the vehicle body across right and left width directions relative to a moving direction of the vehicle body;
an extensible jack device comprised with two or more cylinders which have different diameters and can extend and contract between a position where the cylinders are stacked and accommodated inside and outside and the other position where the inner cylinder protrudes and extends, a ground plate which contacts with a ground contact surface and is attached to an end of the cylinder in a freely rotatable manner and a linkage part which is provided between the cylinder and the ground plate and serves as a ground swing fulcrum;
accommodation bracket members provided in the frame member in order to accommodate the extensible jack device in a freely attachable and detachable manner; and
a jack device supporting bracket member provided in a center part in the right and left directions of the frame member in order to link and support the extensible jack device in a position inclined forward relative to the vertical direction after being detached from the accommodation bracket members, wherein
in an initial state of being linked to the jack device supporting bracket member, the extensible jack device is supported in a position inclined forward relative to the vertical direction by the jack device supporting bracket member in a state that the linkage part serves as a ground swing fulcrum, wherein in association with successive extension, the jack device is brought into a rearward inclined position via a vertical position and then is supported in the rearward inclined position by the jack device supporting bracket member.

2. A riding lawn mower according to claim 1, wherein a floor is provided that covers from the above the lawn mower unit supported by the vehicle body, and an cover that can be opened and closed and that covers the frame member, the accommodation bracket members, and the jack device supporting bracket member is provided in front of the floor.

3. A riding lawn mower according to claim 1, wherein a reinforcement support members that supports and reinforces the cover when the cover is closed is provided between the accommodation bracket members and the cover.
